(19) United States
(12) Patent Application Publication
(10) Pub. No.: US 2011/0155766 A1
(43) Pub. Date: Jun. 30, 2011

(54) MOUNTABLE HAND SANITIZER STATION

(76) Inventor: Timothy R. Hurley, Boynton Beach, FL (US)

(21) Appl. No.: 12/979,791

(22) Filed: Dec. 28, 2010

Related U.S. Application Data
(60) Provisional application No. 61/290,280, filed on Dec. 28, 2009.

(51) Int. Cl. B67D 7/84

(52) U.S. Cl. 222/180

(57) ABSTRACT

A portable hand sanitizing station that is adapted for mounting on a variety of supporting surfaces is disclosed. A main hand sanitizing station body has a housing that includes a re-fillable reservoir for receiving and containing a hand sanitizing substance, a downwardly projecting sanitizer dispensing outlet, and a manually actuated trigger for controlled dispensing of hand sanitizing substance from the reservoir through the dispensing outlet. A clamp allows the hand sanitizing station body to be removably affixed to a supporting surface, such as the edge of a table or the like. The clamp is preferably configured to allow the hand sanitizing station to be removably mounted to the edge of a horizontally disposed surface, and alternately to the edge of a vertically disposed surface. By providing a portable hand sanitizing station that may be removably mounted to a supporting structure, the present invention provides a hand sanitizer apparatus that may be quickly and easily deployed in the field to provide a temporary hand sanitizing station capable of dispensing a significant quantity of hand sanitizer.

### CROSS REFERENCE TO RELATED APPLICATIONS

This application claims the benefit of provisional U.S. patent application Ser. No. 61/290,280, filed on Dec. 28, 2009.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention relates generally to dispensers of hand sanitizing substances, and more particularly to a portable hand sanitizer station that is specifically adapted for mounting on a table or other supporting structure.

2. Description of Related Art

People of all ages become sick with cold and flu viruses. Children, the elderly, and people with weakened immune systems are most susceptible and more likely to have serious complications. The Rhinovirus is the most common cause of the common cold. The flu is caused by the influenza virus, and there are many different strains that mutate frequently. Both the Rhinovirus and influenza virus can be spread via aerosols of respiratory droplets and from contaminated surfaces, including person-to-person contact. Every year in the United States, on average, 5%-20% of the population get the flu, more than 200,000 people are hospitalized from seasonal flu complications, and about 36,000 die from seasonal flu.

According to the U.S. Center for Disease Control (“CDC”), there are a number of everyday steps people can take to protect against infection by cold and flu viruses. Among those steps are washing one's hands with soap and water, or a hand sanitizing substance. In recent years, the use of hand sanitizers has increased as manufacturers provide hand sanitizers in small portable dispensing containers. In addition, fixed hand sanitizer dispensing stations can be found in hospitals, shopping malls, retail stores, and a wide variety of public places. While the use of portable dispensing containers and a limited number of fixed hand sanitizer stations in select locations have made hand sanitizer more available and thus useful in maintaining a healthy population, the availability of hand sanitizer remains limited.

One disadvantage present with small portable hand sanitizer dispensing containers is that such containers are generally for personal use, e.g. use by the individual in possession, and does not provide a source of hand sanitizer accessible by others.

Examples of fixed hand sanitizer dispensing stations are disclosed in the following references: U.S. Pat. No. 4,360,130, issued to Nishimura et al., which discloses a wall mounted dispenser permanently mounted using fasteners; U.S. Pat. No. 4,470,523, issued to Spector, which discloses a liquid soap dispenser secured to a wall using pressure-sensitive adhesive. Further, U.S. Pat. No. 5,265,772, issued to Bartasevich et al., discloses a wall mounted soap dispenser that typifies the wall mount units in the art. A disadvantage present with fixed hand sanitizing stations and dispensers is limited access due to the permanently installed nature of the hand sanitizing station which thus limits access thereto to persons in the immediate vicinity. Accordingly, there exists a need for advancement in the art of hand sanitizer distribution. More particularly, there exists a need for a portable hand sanitizer dispensing station that may be removably mounted to a supporting structure to allow for the station to be removably mounted in a desired location or work area for temporary use.

### BRIEF SUMMARY OF THE INVENTION

The present invention overcomes the limitations and disadvantages present in the art by providing a portable hand sanitizing station that is adapted for mounting on a variety of supporting surfaces. A mountable hand sanitizing station in accordance with the present invention includes a main hand sanitizing station body having an upper portion and a lower portion. The upper portion includes a housing that includes a re-fillable reservoir for receiving and containing a hand sanitizing substance, a downwardly projecting sanitizer dispensing outlet, and a manually actuated trigger for controlled dispensing of hand sanitizing substance from the reservoir through the dispensing outlet. The lower portion includes a clamp to allow the hand sanitizing station body to be removably affixed to a supporting surface, such as the edge of a table or the like. The clamp is preferably configured to allow the hand sanitizing station to be removably mounted to the edge of a horizontally disposed surface, and alternately to the edge of a vertically disposed surface. By providing a portable hand sanitizing station that may be removably mounted to a supporting structure, the present invention provides a hand sanitizer apparatus that may be quickly and easily deployed in the field to provide a temporary hand sanitizing station capable of dispensing a significant quantity of hand sanitizer.

Accordingly, it is an object of the present invention to provide an improved hand sanitizing station.

Another object of the present invention is to provide a portable hand sanitizing station that is mountable to a supporting surface.

Still another object of the present invention is to provide a portable hand sanitizing station that may be removably mounted to the edge of either a horizontal or vertically disposed surface.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a rear perspective view of a mountable hand sanitizer station in accordance with the present invention;

FIG. 2 is a front perspective view thereof; and

FIG. 3 is a side view of a hand sanitizer station in a configuration mounted to the edge of a horizontally disposed surface;

FIG. 4 is a side view of an alternate embodiment hand sanitizer station incorporating if hinged link between the upper and lower portions to allow for a configuration mounted to the lower edge of a vertically disposed surface; and

FIG. 5 is a rear perspective view of an alternate embodiment hand sanitizer station having a rotatable mount configured for attachment to a vertically disposed structure.

### DETAILED DESCRIPTION OF THE INVENTION

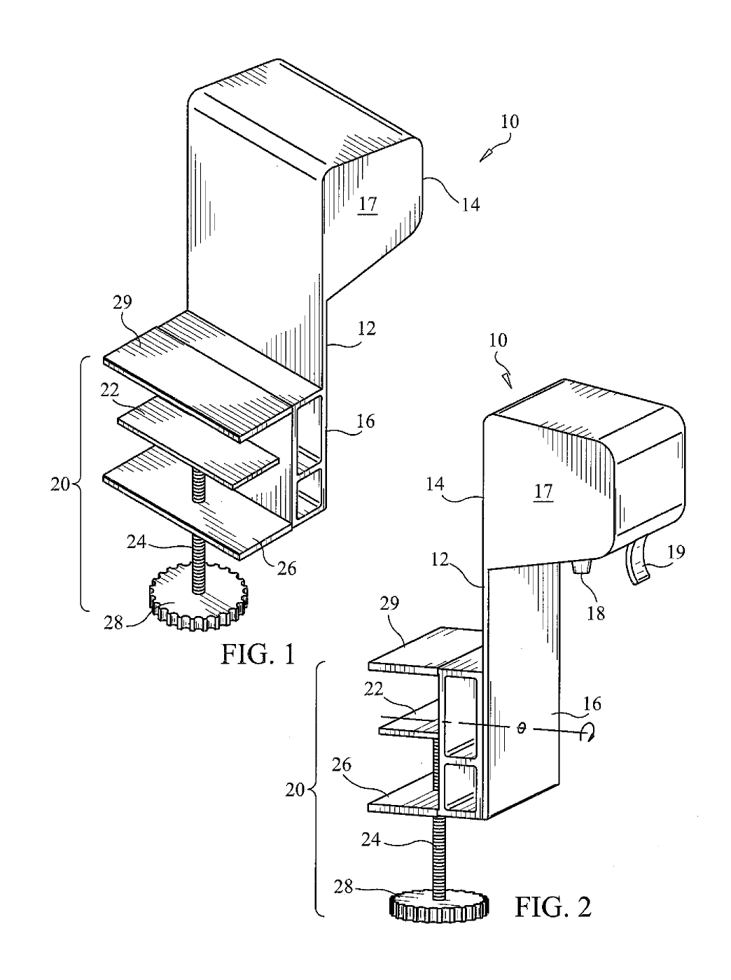

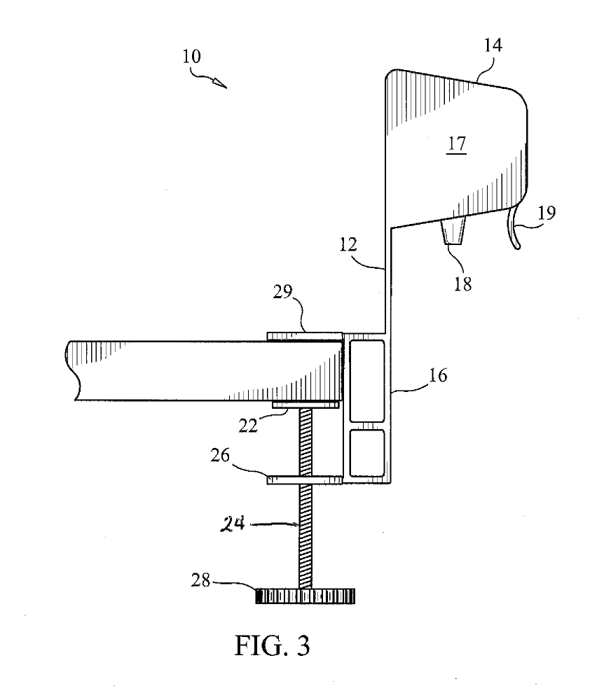

With reference now to the drawings, FIGS. 1-5 depict a preferred embodiment of a mountable hand sanitizer dispensing station, generally referenced as 10, in accordance with the present invention. As used herein the term “hand sanitizer” or “sanitizer” means any type of sanitizing fluid used for personal hygiene, particularly for the cleansing and sanitizing of a person's hands. As best seen in FIGS. 1-3, hand sanitizer station 10 comprises a portable hand sanitizing station that is adapted for mounting on a variety of supporting surfaces. Hand sanitizing station 10 preferably includes a main hand sanitizing station body 12 having an upper portion 14 and a lower portion 16. Upper portion 14 includes a housing 17 that includes a re-fillable reservoir for receiving an containing a hand sanitizing substance, a downwardly projecting sanitizer dispensing outlet 18, and a manually actuated trigger 19 for controlled dispensing of hand sanitizing substance from the reservoir through dispensing outlet 18. Trigger 19 may be operatively connected to an internally disposed pumping mechanism to forcefully eject hand sanitizer via dispensing outlet 18.

The lower portion includes a clamp assembly, generally referenced as 20, to allow the hand sanitizing station body to be removably affixed to a supporting surface, such as the edge of a table or the like. Clamp assembly 20 includes a clamp member 22 connected to a first end of a threaded member 24. Threaded member 24 is in threaded engagement with a flange 26 projecting from the lower portion 16 of main hand sanitizing body 12. A handle 28 is affixed to a second end of threaded member 24 to allow for adjustment clamp member 22 relative to a stop 29 projecting from the lower portion 16 of main hand sanitizing body 12. As should be apparent, clamp assembly 20 allows the hand sanitizing station body 12 to be removably mounted to the edge of a horizontally disposed surface, such as a table. In an alternate embodiment, clamp assembly 20 is pivotally connected to the lower portion 16 such that hand sanitizing body 12 may be mounted to the edge of a vertically disposed surface. By providing a portable hand sanitizing station that may be removably mounted to a supporting structure, the present invention provides a hand sanitizer apparatus that may be quickly and easily deployed in the field to provide a temporary hand sanitizing station capable of dispensing a significant quantity of hand sanitizer.

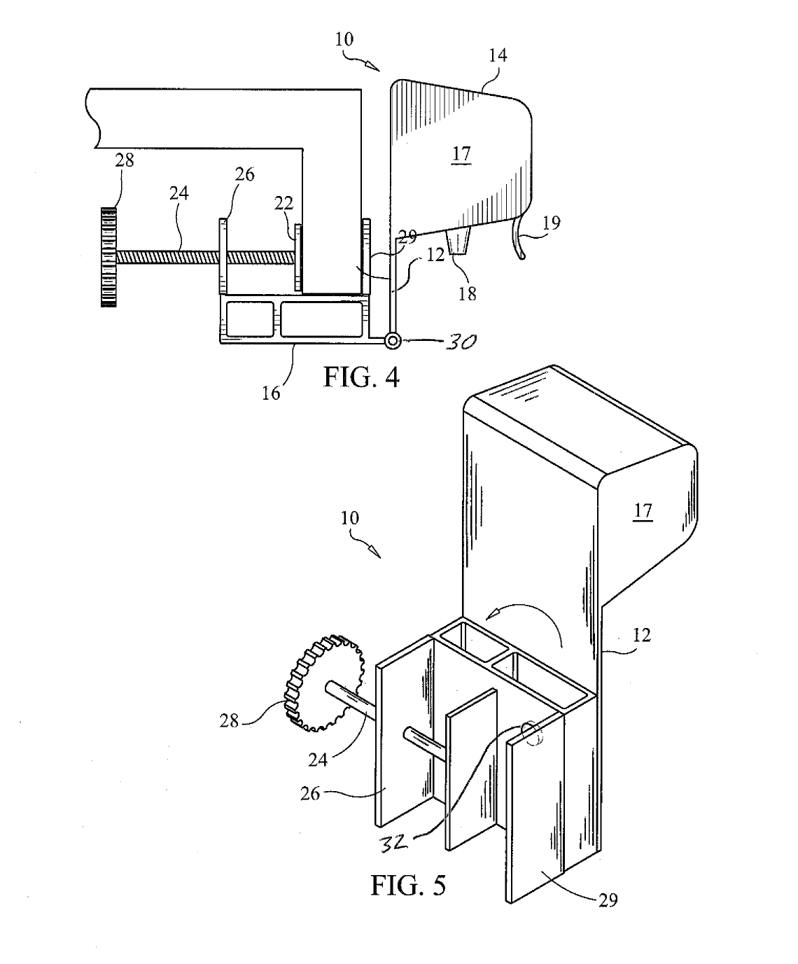

FIG. 4 depicts an alternate embodiment of hand sanitizer dispensing station 10 including a hinged connection, generally referenced as 30, disposed between the upper portion 14 and lower portion 16 to allow for articulation of upper portion 14 relative to lower portion 16. Hinge connection 30 is preferably adapted for movable yet locking angular positioning thereby allowing the user to adjust the angular disposition between upper and lower portions, 14 and 16, to any suitable angular relation. As best illustrated in FIG. 4, the inclusion of hinge connection 30 allows for hand sanitizer dispensing station 10 to be attached to the lower or bottom edge of a vertically disposed structure.

FIG. 5 depicts yet another alternate embodiment of hand sanitizer dispensing station 10, wherein clamp assembly 20 is rotatably mounted relative to lower portion 16 via connection therebetween via a pin 32. More particularly, pin 32 functions as an axis for rotational adjustment between clamp assembly 20 and the lower portion 16 of hand sanitizer dispensing station 10 to allow for removable mounting thereof along the vertically disposed edge of a supporting structure.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A portable and removably mountable hand sanitizer dispensing station adapted for mounting a variety of supporting surfaces, said hand sanitizer dispensing station comprising:
a main hand sanitizing station body having an upper portion and a lower portion;
said upper portion having a housing that includes a re-fillable reservoir for receiving and containing a hand sanitizing substance, a downwardly projecting sanitizer dispensing outlet, and a manually actuated trigger for controlled dispensing of hand sanitizing substance from the reservoir through the dispensing outlet;
said lower portion includes a clamp to allow the hand sanitizing station body to be removably affixed to a supporting surface.

2. A hand sanitizer dispensing station according to claim 1 wherein said clamp is configurable between a first configuration wherein said hand sanitizing station is removably mounted to the edge of a horizontally disposed surface, and a second configuration wherein said hand sanitizing station is removably mounted to the edge of a vertically disposed surface.

3. A portable and removably mountable hand sanitizer dispensing station adapted for mounting a variety of supporting surfaces, said hand sanitizer dispensing station comprising:
a main hand sanitizing station body having an upper portion and a lower portion;
said upper portion having a housing that includes a re-fellable reservoir for receiving and containing a hand sanitizing substance, a downwardly projecting sanitizer dispensing outlet, and a manually actuated trigger for controlled dispensing of hand sanitizing substance from the reservoir through the dispensing outlet;
said lower portion includes a clamp to allow the hand sanitizing station body to be removably affixed to a supporting surface;
said clamp being configurable between a first configuration wherein said hand sanitizing station is removably mounted to the edge of a horizontally disposed surface, and a second configuration wherein said hand sanitizing station is removably mounted to the edge of a vertically disposed surface.

4. A hand sanitizer dispensing station according to claim 3, further including a hinged connection disposed between said upper portion and said lower portion to allow for articulation of upper portion relative to lower portion.

5. A hand sanitizer dispensing station according to claim 3, wherein said clamp assembly is rotatably mounted relative to lower portion via a pin that functions as an axis for rotational adjustment between said clamp assembly and said lower portion to allow for removable mounting thereof along the vertically disposed edge of a supporting structure.
